(19) United States
(12) Patent Application Publication
(10) Pub. No.: US 2009/0248837 A1
(43) Pub. Date: Oct. 1, 2009

(54) Online report system and method for optical disc formats with enhanced interactivity features

(75) Inventor: Paulette E. Pantoja, Sherman Oaks, CA (US)

Correspondence Address: Niro, Scavone, Haller & Niro, Suite 4600, 181 W. Madison, Chicago, IL, 60602, US

(73) Assignee: BluFocus, Inc.

(21) Appl. No.: 12/383,113

(22) Filed: Mar. 19, 2009

Related U.S. Application Data
(60) Provisional application No. 61/070,265, filed on Mar. 21, 2008.

(51) Int. Cl. G06F 15/16

(52) U.S. Cl. 709/218

(57) ABSTRACT

An online quality assurance system and method for optical disc formats with enhanced interactivity features is disclosed. Specifically, the system and method provides a means for various studios, DVD player manufacturers, DVD standards specification providers, authoring facilities, and DVD standards tool developers to each provide and receive input, preferably in realtime, about research, development, and production issues, problems, and solutions.

This application claims priority from U.S. Patent Provisional Application Ser. No. 61/070,265, filed on Mar. 21, 2008. Application No. 61/070,265 is hereby incorporated by reference.

### FIELD OF THE INVENTION

The present invention relates generally to an interactive quality control system and method, and specifically a system and method to allow multiple manufacturers and service and content providers to provide input including problems and solutions with the development and production of optical discs with enhanced interactivity features. More specifically, the present invention includes a system and method for generating a online reporting system to ensure the quality control of high definition, advanced format video discs such as BD-J/BD-Live formats.

### BACKGROUND OF THE INVENTION

With the onslaught of high definition television, there is an accompanying increase in the demand to provide high content and more complex content. One of the most ubiquitous formats for viewers to consume such high definition content is digital video discs (DVDs). Recently, the consumer electronics industry has settled upon a single format for high definition video discs, the so-called Blu-ray format developed by Sony.

The creation of a de facto standard is expected to increase demand for such higher definition discs, as well as an increased demand for a variety of additional content and connectivity. Blu-ray authored content is becoming more unique and complex as Creative vendors and Authoring Facilities are re-thinking the DVD design and developing new functionality. For instance, there is believed to be an increased demand for features such as game content (though a BD-J enable game), picture in picture features, and internet connections (though a BD-Live feature). In other words, while it is becoming a de facto standard, Blu-ray is and will be a constantly evolving format thanks to Java and other enhanced features. Titles will not become like standard DVD solutions, using cookie cutter format templates. Each title will be unique and complex.

As with any format, it is important that accurate and thorough testing is completed to ensure correct operation and compatibility. There is a need for efficient troubleshooting, reporting, and management to give enough time for investigation and for revisions to be made without unduly impacting cost and production schedules for a variety of entities along the production process, including:

Studios

Player Manufacturers

Blu-ray Specification changes/updates

Authoring Facilities

Blu-ray tool developers

High definition DVD production is a fast paced and time sensitive industry. It is extremely necessary that testing is done efficiently and accurately to avoid negative impact on the production schedule.

Many present solutions incorporate a monolithic model that assumes a “cookie cutter” approach to the release of a given DVD. Current facilities are only involved at the last stages of production. These solutions are typically built with an assumption that the underlying business processes are static and will not change, e.g., to allow for differences in functionality including, but not limited to gaming, internet connectivity and the like. As a result, these present solutions are inherently limited, and lack the ability to offer feedback on the testing requirements, feedback, and solutions reached by each stage of the development process.

Current products and systems for managing DVD quality assurance are generally unable to provide the flexibility, performance, and robustness required to manage truly effective quality assurance reporting systems that provide the best and most cost effective production schedule for studios, DVD player manufacturers, authoring facilities, tool developers, and standards authorities.

### SUMMARY AND OBJECTS OF THE INVENTION

It is an object of embodiments of the present invention to provide a system that allows for on-line quality assurance to identify and troubleshoot high definition DVD research & development and Production associated with disc authoring and players, preferably on a realtime basis.

Another object of some of the preferred embodiments of the present inventions is to provide an on line reporting system to ensure the overall quality and playability of high definition DVD titles, by working on line directly with groups during production and/or the research and development phases to provide unique solutions previously unavailable to the DVD industry.

It is a further object of embodiments of the present invention to provide a system and method for the automatic and selective realtime notification of authoring facilities, studios, player manufacturers and other participating entities of relevant troubleshooting problems, solutions and other quality assurance information.

A system and method for providing an online reporting system for use in the quality assurance of optical disc formats with enhanced interactivity features (e.g., so called Blu-ray DVD discs with BD-J or BD-Live capability) is described.

The system of the present invention typically includes one or more client computers which generates development and/or production influencing events, which are then sent to a server computer. The server computer, depending upon the identity of the client, presents a variety of options (e.g., in one or more pull down menus) which allow the client to upload and/or input information related to relevant development and/or production influencing events. The server computer of the present invention then stores or receives and places such input or uploaded information on a database which, depending upon the information received from the client computer, may direct the information to other clients for notification of the uploaded/input event information.

Other features and advantages of the present invention will be apparent from the accompanying drawings and from the detailed description that follows.

### BRIEF DESCRIPTION OF THE DRAWINGS

The present invention is illustrated by way of example without limitation in the figures of the accompanying drawings in which like references indicate similar elements, and in which:

FIG. 1 illustrates a computer network that includes client computers coupled to a server computer, and that is used to implement certain embodiments of the present invention;

FIG. 2 is an example graphic user interface for a client accessing the computer network that implements certain embodiments of the present invention;

FIG. 3 is an example automatic notice of a design and/or production issue which may be forwarded to selective clients in accord with certain preferred embodiments of the present invention; and

FIG. 4 is an example of a testing report which is used to document a design and/or production issue in accord with the process and system of certain preferred embodiments of the present invention.

### DESCRIPTION OF THE PREFERRED EMBODIMENTS

In the following description, for purposes of explanation, numerous specific details are set forth in order to provide an understanding of the present invention. It will be evident, however, to one skilled in the art that the present invention may be practiced without certain specific details. In other instances, well-known structures and devices are shown in block diagram form to facilitate explanation. The description of preferred embodiments is not intended to limit the scope of the claims appended hereto. In addition, future and present alternatives and modifications to the preferred embodiments described below are contemplated. Any alternatives or modifications which make insubstantial changes in function, in purpose, in structure, or in result are intended to be covered by the claims of this patent.

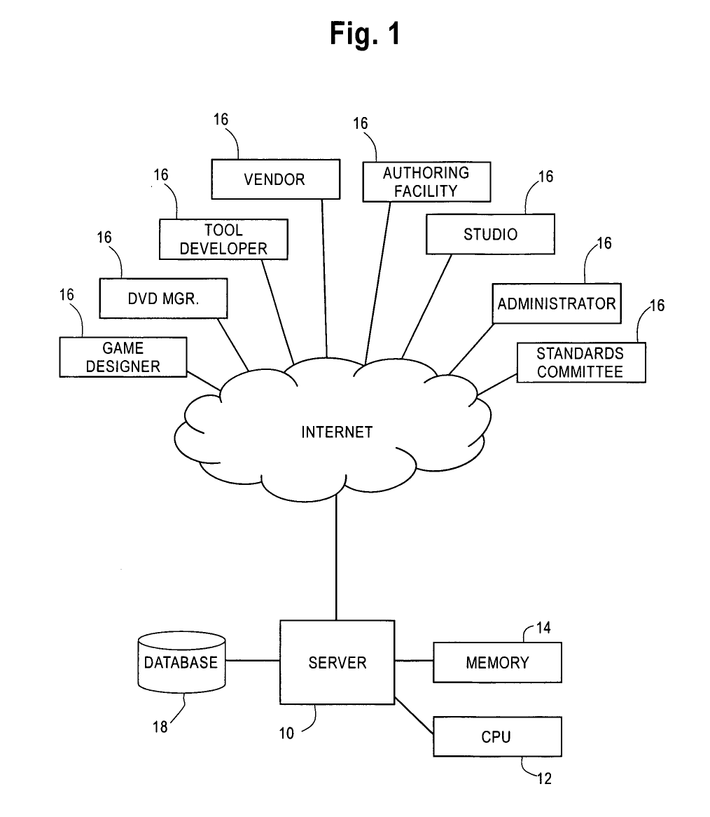

As shown in FIG. 1, the system embodiments of the present invention may be implemented on one or more computers comprising a computer network. According to one embodiment of the present invention, a server computer 10 transmits and receives data over a computer network. The steps of accessing, downloading or uploading, and manipulating the data, as well as other aspects of the present invention are implemented by a central processing unit (CPU) 12 in the server computer 10 executing sequences of instructions stored in a memory 14. The memory may be a random access memory (RAM), read-only memory (ROM), a persistent store, such as a mass storage device, or any combination of these devices. Execution of the sequences of instructions causes the CPU to perform steps according to embodiments of the present invention.

Information may be uploaded to or input into the server computer 10 from one or more other computer systems over a network connection. For example, a client computer 16 may transmit data to the server computer in response to development and/or production influencing events. As the server receives the upload or input over the network connection, it stores the information in memory. The server may store the information for updating a database 18 in memory 14, and it may automatically output updates or alerts to one or more client computers depending upon the nature of the information the server computer 10 receives. In some cases, the event information may not be directly executable by the CPU, and may instead be executed by a rule set (not shown) that interprets the input and forwards information to select client computers depending upon the rights of various client computers and/or the selection by various clients to receive such automatic notification. In other embodiments, hardwired circuitry may be used in place of, or in combination with, software instructions to implement the present invention. Thus, the present invention is not limited to any specific combination of hardware circuitry and software, nor to any particular source code for the instructions executed by the server or client computers.

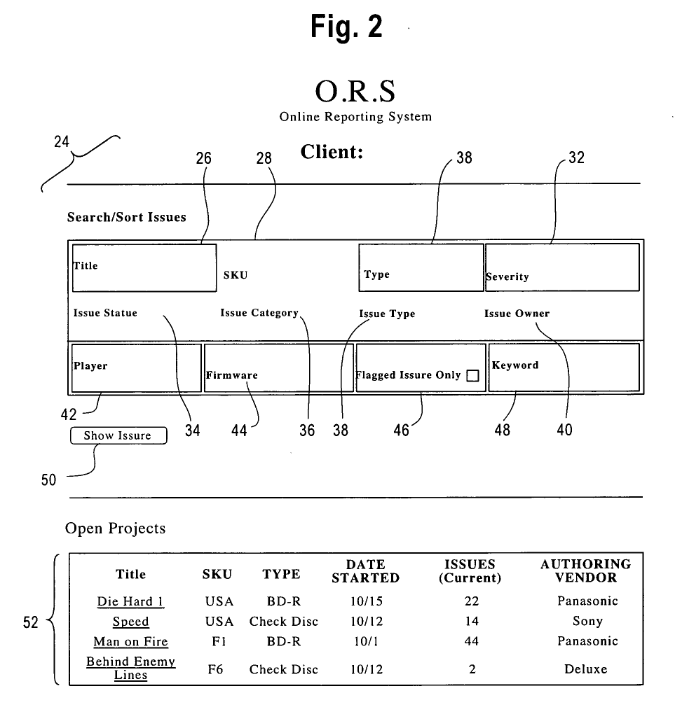

FIG. 2 shows a graphic user interface for various client computers. Prior to accessing this GUI, the client would be expected to provide identification and password to a login screen (not shown) to maintain the security of the computer network. Once the password and login have been validated by the server computer, the server enables a client GUI 24 to be displayed to a client computer 16. The client GUI 24 includes a series of input points/pulldown menus for “search/sort” issues which allow the client to search for a given issue and/or search or organize relevant titles based upon a number of criteria, such as title 26, SKU 28, DVD type 30, severity of issue 32, issue status 34 (e.g., open, closed, verified OK, check, pending), issue category 36 (e.g., logic, navigation, linears, games, compatibility, bonus content), issue type 38 (e.g., video, audio, subtitles, graphics, functionality, UOPS, loading), issue owner 40, (e.g., client, video vendor, audio vendor, game vendor, authoring vendor, menu vendor, player division) player type 42, and firmware type 44, as well as a highlight box 46 to check for flagged issues and a keyword box to enable a plain text and/or boolean type search for descriptive text within the various entries in database 18. Those of ordinary skill in the art having the teaching of the present invention and an understanding of html or similar programming will understand how to enable the pull down menus and input boxes of the client GUI 24. Upon entry of the desired information to be searched and/or sorted, the client will click activation button 50 (“show issues”) which will sort and/or look for the appropriate titles and/or issue records to be displayed. The client GUI 24 will preferably also include a display area 52 which will display the applicable records in response to the client's input search, or absent any search will display a default list (e.g., any open issues for titles associated with the particular client). As but an example, if a client desired to see issues that were limited to certain categories, e.g.:

Status: OPEN

Owner: Authoring

Severity: Medium

Category: Linears

Type: Subs

the client could simply choose the above from drop down lists and click the activation button 50, and it would list the issues responsive to the selected categories in display area 52. In a preferred embodiment, a default display of an issue in display area 52 could preferably be listed automatically:
Check Box (this is so a user can check on this and at the bottom chose to EMAIL the issues checked)
Issue Status
Issue Owner
Issue Severity
Issue Category
Issue Type
Issue Summary
   An example of an issue list for display area 52 would be as follows:

| | Status | Owner | Severity | Category | Type | Outline/Summary |
|---|---|---|---|---|---|---|
| CHECK BOX | Open | Authoring | High | Linears | Subs | When watching the movies, it |
| HERE | | | | | | freezes at 01:03:04 |

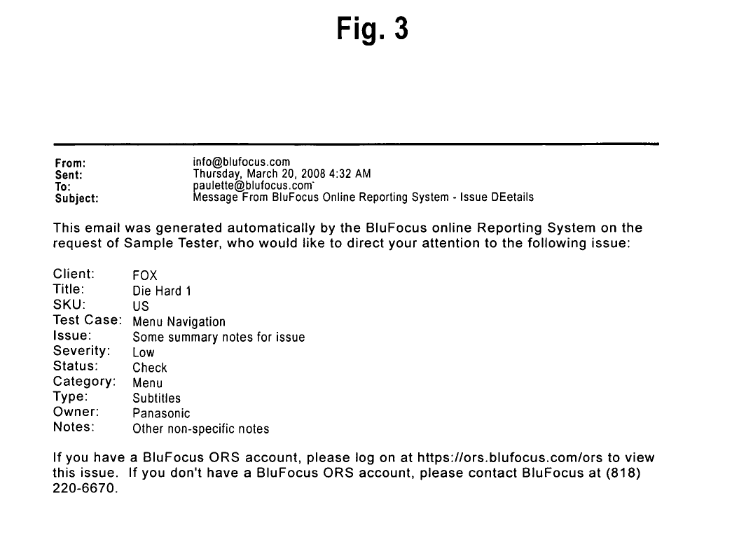

In one alternative preferred embodiment, next to each issue displayed in a display area would be a check box where the client could check off as many issues as the client deems relevant have such issue listings places in an email for the client to send. As would be understood by those of ordinary skill in the art, this feature would include an email button (not shown) which would be at the bottom of the list of issues to be displayed in display area 52. An example of the automatically forwarded email resulting from activating the email button, or from a client opting to receive such notification and having the rights to do so, is attached as FIG. 3.

In another alternative embodiment, the client GUI 24 will enable the entry of additional text to create a new issue record entry for the data base in response to development and/or production influencing events with a given client. Such events may include the entry of a new title with corresponding SKU, type, vendor information, and problems (if any). Likewise, the new entry may be linked or associated with an existing title, or may be the addition to or modification of an existing issue with a given title. In such instances, the client GUI 24 will permit the entry of text in display area 52 which will provide any relevant information related to the development and/or production influencing events. In addition, the display area 52 will include a feature for linking files or other records related to the development and/or production influencing event which may be stored on data base 15 and/or shared with other clients.

In one preferred embodiment of the present invention, the client GUI 24 will include the ability to enable an administrator identity which will grant any specific client GUI 24 operated by the administrator additional rights to configure and link the information passed by the network. For instance, the administrator can establish various levels of rights which may limit a given client (e.g., content author and/or player manufacturer) to only those titles for which they are involved. In addition, the administrator may enable rules either on its own or in response to client input which enables the automatic forwarding of information to other clients based upon their relatedness to a given development and/or production issue. For instance, a given client may want to know about any production problems with every title that it has worked on and thus may want to automatically receive notices from any other client related to that title. Other clients for a given title may not be concerned about any issues for which a vendor has claimed responsibility and, thus, may “opt out” of such automatic notices. At least one preferred embodiment of the present invention will include a series of rules (not shown) which are incorporated into the server computer 12 in response to the grant of rights of the administrator and the preferences of each given client.

In a further alternative embodiment of the present invention, the administrator could establish different levels of rights for having access to different levels of information, as well as different rights to change or add to such information. For instance, the administrator could establish the following different rights levels for use of the client GUI 24:

DVD Tester—Access to view/change all
Studio—Access to view all but change only
Issue Status
Issue Owner
Issue Severity
Issue Notes
   Vendor—Access to view only their issues (Authoring, Game, Audio, Video) and only change:
Issue Notes
   Guest—Access to only view issues but not change anything. But Guest will be granted to only view what is selected for them (e.g., title by a particular studio, or issues that are related to only a certain player, etc,).
   With this alternative embodiment, the system and method would permit the administrator to have complete control over the transmission of issues to a plurality of different third party client computers, with each client computer having a differing level of access to view and modify issues depending upon their rights.

This server computer 10 and database 18 as used in this system may also enable a variety of additional functions, including a “knowledge trend flow chart,” a reporting output document feature, and a post production release feedback mechanism via a computer website version of the client GUI 24.

Most preferably, the Consumer website would be a mechanism for a client GUI 24, where consumers can log on (after account set up) and submit any issue they are experiencing with a title they have purchased. The computer network administrator can monitor the issues entries by consumers, which are entered in a similar fashion to other client GUI entries. When a particular title has raised enough concern (either by number or issues or severity or combination of both), the administrator will launch an investigation and test on that title. If necessary, the administrator will facilitate the creation of a test report which will then be sent to the studio and/or DVD player manufacturer regarding the issue. This reinforces the belief for consumers that there is an oversight process for monitoring and addressing their issues and for speaking directly about such issues with the studios and player manufacturers (currently, by contrast, consumers must contact the studios and DVD player Manufacturers directly either by email or 800 number).

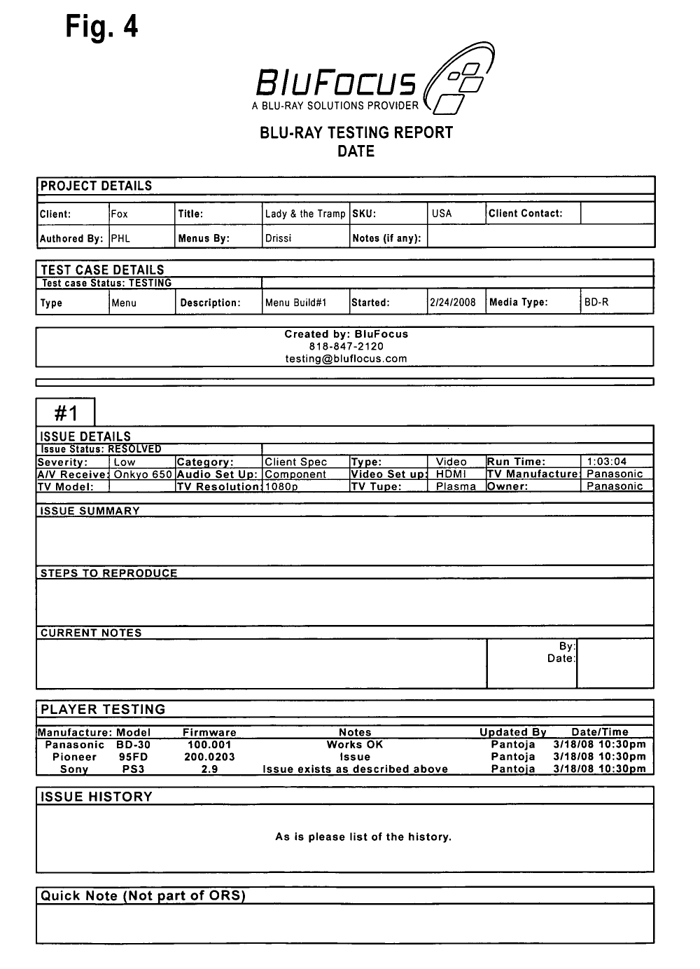

Most preferably, the information received from each of the client GUIs 24 will be stored in database 18 and will be accessible to a given client GUI via licensing. Within this license, reporting can be done to view issues based on title, player, region, location, and the like. Ideally, any information entered on the form and registration process of client GUI 24 will be accessible to whomever licenses the reporting membership. This system capability will provide an understanding of what types of players, firmware and titles have issues, and assist studios, authoring companies and player manufacturers when developing new products. An example of a testing report which could be made available pursuant to the claimed invention (“as is” or in modified form to protect the confidential information of third parties) is attached hereto as FIG. 4.

While in one preferred embodiment the information stored in database 18 will be used for issues arising with titles during development and production, another alternative embodiment of the present invention will include using the issue information stored in database 18 for later use by studios, DVD player manufacturers and the like for their predictive capabilities in future title projects The server computer 12 will be able to process historical information from database 18, to generate charts, graphs, and statistical analysis. For instance, upon receipt from a query from a given client GUI 24, server 12 and database 18 could generate and supply information identifying the frequency of a type of issue occurrence for a given DVD player for a given region's titles provided by a given studio during a given time period, e.g., the number of Audio issues occurred on the Panasonic BD-30 for Region A titles by FOX during the timeframe of Jan. 1, 2008-Mar. 1, 2008.

Additional optional features that may be included in certain preferred embodiments of the present invention include a contact management system, a project outline and workflow management system, and an asset tracking system. In the contact management system, the server, through information and details on clients and their contact information, would be capable of associating with actual tests of interest and be able to email issues and related test of issues that are of interest directly to such clients. A project outline and workflow feature could—using the server computer 12 in conjunction with historical information in database 18, create estimates for when projects should be completed and submitted for testing, as well as monitoring and comparing such time estimates with actual development and/or production times as well to report production issues and successes. Additionally, the database 18 can receive, store and automatically provide tracking information for assets (e.g., production DVD copies) delivered to a given client facility (e.g., from receiving barcode information from a client GUI 24 or its barcode scanner equivalent). The database 18 can thus track assets (and automatically notify clients, where desired), and identify assets attached to certain projects and test cases. Finally, the server computer 12 and database 18 in certain preferred embodiments may host and manage documentation regarding a given client's specifications along with an approval and rejection option for the client. With this feature, a given client may upload new specifications or approve ones uploaded by another client facility. The purpose of this feature would be to ensure that the testing facility always has the latest and correct specification when testing.

In the foregoing, a system has been described for deploying and managing an on line quality assurance reporting system for high definition DVDs with variable enhanced features. Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarding in an illustrative rather than a restrictive sense.

What is claimed is:

1. An online quality assurance method for optical disc formats with enhanced interactivity features, said method comprising the steps of;
a. storing information regarding design and production influencing events for optical disc formats with enhanced interactivity features;
b. adding design and production issues in response to input information regarding said design and production influencing events from third party client computers for at least audio, video, game content, and connectivity category issues; and
c. automatically and selectively forwarding information to other third party computers regarding said design and production issues depending upon the user rights of said third party computers.
